(19) United States
(12) Patent Application Publication
(10) Pub. No.: US 2008/0292921 A1
(43) Pub. Date: Nov. 27, 2008

(54) RECOVERY OF INERT GAS FROM A FUEL CELL EXHAUST STREAM

(76) Inventors: BALASUBRAMANIAN LAKSHMANAN, Pittsford, NY (US); Matthew M. Fay, Fairport, NY (US); Martin Woehr, Weilheim (DE); Hubert A. Gasteiger, Rochester, NY (US); George R. Woody, Redondo Beach, CA (US); David A. Masten, Rochester, NY (US)

Correspondence Address: FRASER CLEMENS MARTIN & MILLER LLC, 28366 KENSINGTON LANE, PERRYSBURG, OH, 43551-4163, US

(21) Appl. No.: 11/751,725

(22) Filed: May 22, 2007

(51) Int. Cl. H01M 8/04; H01M 8/22

(52) U.S. Cl. 429/17; 429/19; 429/34

(57) ABSTRACT

A fuel cell system is provided including a fuel cell stack having a fuel cell having an anode, an anode outlet, an anode inlet, and a cathode. The fuel cell system further includes a hydrogen pump in communication with the anode outlet and the anode inlet. The hydrogen pump features a proton exchange membrane disposed between a first electrode and a second electrode. The first electrode is configured to accept an anode outlet stream from the anode outlet, the anode outlet stream including a hydrogen gas and an inert gas, the first electrode being configured to exhaust the inert gas. In one embodiment, the hydrogen pump is in communication with a PROX unit and configured to provide the hydrogen gas to the fuel cell stack. Further provided are methods employing the hydrogen pump wherein a start-stop degradation of the fuel cell is militated against and a hydrogen feed stream is humidified.

### FIELD OF THE INVENTION

The present invention relates to fuel cell systems and more particularly to a method for inhibiting start-stop degradation and humidifying a hydrogen fuel in a fuel cell assembly.

### BACKGROUND OF THE INVENTION

Fuel cells have been proposed as a clean, efficient and environmentally responsible power source for electric vehicles and various other applications. One example of a fuel cell is the Proton Exchange Membrane (PEM) fuel cell. The PEM fuel cell includes a membrane-electrode-assembly (MEA) that generally comprises a thin, solid polymer membrane-electrolyte having an electrode with a catalyst, for example an anode or a cathode, on both faces of the membrane-electrolyte.

The MEA generally comprises porous conductive materials, also known as gas diffusion media, which further form the anode and cathode layers. Fuel, such as hydrogen gas, is introduced at the anode where it reacts electrochemically in the presence of the catalyst to produce electrons and protons. The electrons are conducted from the anode to the cathode through an electrical circuit. Simultaneously, the protons pass through the electrolyte to the cathode where an oxidant, such as oxygen or air, reacts electrochemically with the electrons and the protons in the presence of the catalyst to produce water.

The MEA is generally interposed between a pair of electrically conductive contact elements or bipolar plates to complete a single PEM fuel cell. Bipolar plates serve as current collectors for the anode and cathode, and have appropriate flow channels and openings formed therein for distributing the fuel cell's gaseous reactants (i.e., the H₂ & O₂/air) over the surfaces of the respective electrodes. Bipolar plates can be assembled by bonding together two unipolar plates having the flow distribution fields formed thereon. Typically, bipolar plates also include inlet and outlet headers which, when aligned in a fuel cell stack, form internal supply and exhaust manifolds for directing the fuel cell's gaseous reactants to and from a plurality of anodes and cathodes. The bipolar plates also can include a flow distribution field and an inlet header and an outlet header for distribution of a liquid coolant.

Fuel cell systems of the art can employ hydrogen recirculation systems to reduce the amount of hydrogen exhausted from the fuel cell stack. Reducing the hydrogen content of the exhaust is desirable from an efficiency standpoint, as the hydrogen can still be used as a gaseous reactant in the fuel cell. A reduction in hydrogen emissions is also desirable for environmental reasons.

A system is reported by Barbir et al., in U.S. Pat. No. 6,994,929 that includes an electrochemical hydrogen compressor which electrochemically separates hydrogen from byproducts and recirculates the hydrogen gas to the fuel cell. Also known is an anode recirculation system reported by Yang et al. in U.S. Pat. No. 6,999,610 that includes a pump for discharging excess hydrogen from the fuel cell and back into the piping of a hydrogen supply to be mixed with fresh hydrogen.

Typically, hydrogen recirculation continues until excess non-reactive or inert gases, e.g. nitrogen, accumulate to an undesirable level. At a predetermined level, the inert gases can limit the concentration of the gaseous reactants to a point where fuel cell reactant starvation can occur. Nitrogen gas can accumulate, for example, by crossing over to the anode from the cathode where air is used as an oxidant. Conventional hydrogen recirculation systems can include a bleed valve that releases the recirculating anode gases before the undesirable nitrogen levels are reached.

Furthermore, it is well known that upon and during start-up and shut-down of the cell the presence of air on the cathode coupled with a hydrogen-air front on the anode can cause undesirable potentials. For example, the presence of air on the cathode at start-up or shut-down can lead to a high potential on the cathode. This enables an oxidation of carbon and results in a performance degradation. In particular, corrosion of the electrodes having a carbon substrate, wherein surface oxides, CO, and CO₂ are formed, is a concern. Cumulatively, these phenomena are known as fuel cell “start-stop degradation.”

U.S. Pat. No. 6,939,633 to Goebel reports that start-stop degradation can be inhibited in fuel cell systems by recirculating the cathode gases with bleed hydrogen through the cathode. Recirculating the cathode gases results in a reaction between residual oxygen in the recycled gases until substantially all of the oxygen is reacted, leaving a substantially oxygen-free, predominately nitrogen compound in the cathode. Also, in U.S. Pat. No. 6,635,370 to Condit et al., it is disclosed that inert gases, e.g. nitrogen, can be used to purge the anode and cathode flowfields immediately upon cell start-up or shut-down. The purge passivates the electrodes to minimize cell performance degradation. Such systems militate against start-stop degradation, also known as start-stop mitigation, by inhibiting the formation of the undesirable voltage potentials that could otherwise damage the fuel cell catalysts or catalyst supports.

It is further known that membranes within a fuel cell need to have a certain relative humidity to maintain an ionic resistance across the membrane within a desired range to effectively conduct protons. Generally, if the humidity is too low, the PEM will be dehydrated and cause the protonic resistance of the fuel cell to increase while the voltage decreases. This can result in an expected life cycle of the fuel cell being shortened. On the other hand, if the humidity is too high, the flow channels can become blocked by accumulating water in a phenomenon known as “stagnation.” Water stagnation can inhibit or prevent the flow of the gaseous reactants and seriously impair the performance of the fuel cell.

There is a continuing need to exhaust accumulated inert gases and minimize the start-stop degradation of fuel cell stacks without requiring the use of traditional tanks, pumps, valves, and related components, all of which affect weight, volume or complexity of the fuel cell system. Desirably, the method will include an opportunity to humidify the gaseous reactants, in particular the hydrogen gas being supplied to the anode layers of the fuel cell stack.

### SUMMARY OF THE INVENTION

In concordance with the instant disclosure, a fuel cell system that exhausts accumulating inert gases, militates against fuel cell start-stop degradation, humidifies a hydrogen feed stream, and optimizes the system weight and volume is surprisingly discovered.

In one embodiment, a fuel cell system is provided with a fuel cell stack including a fuel cell having an anode and a cathode, the fuel cell stack further including an anode outlet and an anode inlet, and a cathode. The fuel cell system includes a hydrogen pump in communication with the anode outlet and the anode inlet, the hydrogen pump including a proton exchange membrane. The proton exchange membrane is disposed between a first electrode and a second electrode that are in electrical communication with a power source. The first electrode is configured to accept an anode outlet stream having a hydrogen gas and an inert gas from the anode outlet, and a second electrode that is configured to supply at least a portion of the hydrogen gas to the anode inlet. The first electrode is also configured to exhaust the inert gas.

In an additional embodiment, a fuel cell system is provided including the fuel cell stack, a fuel processor adapted to generate a reformate stream from a hydrocarbon source, the reformate stream including a hydrogen gas and a carbon monoxide gas, a preferential oxidation unit in communication with the fuel processor and configured to oxidize the carbon monoxide gas and form a carbon dioxide gas, and the hydrogen pump in communication with the preferential oxidation unit. The hydrogen pump is adapted to receive and separate the hydrogen gas and the carbon dioxide gas from the preferential oxidation unit. The hydrogen pump is further configured to supply the hydrogen gas to the fuel cell stack.

In a further embodiment, a method for operating a fuel cell system is described and includes first introducing an anode outlet stream from a fuel cell stack to the hydrogen pump, wherein the anode outlet stream includes a hydrogen gas and an inert gas. Second, a potential is applied across the proton exchange membrane of the hydrogen pump and at least a portion of the inert gas is separated from the anode outlet stream. Third, a cathode inlet stream that includes the inert gas is supplied to the fuel cell stack during a start-up phase and/or a shut-down phase of the fuel cell stack.

An additional method for operating a fuel cell system is provided that includes introducing the anode outlet stream from the fuel cell stack to the hydrogen pump, applying a potential across the proton exchange membrane of the hydrogen pump, separating at least a portion of the hydrogen gas from the anode outlet stream, and humidifying a hydrogen feed stream from, for example, a hydrogen storage device. The method further includes supplying an anode inlet stream including the humidified hydrogen feed stream to the fuel cell stack.

A further method for operating a fuel cell system includes introducing a reformate stream from a fuel processor to a preferential oxidation unit, the reformate stream including a hydrogen gas and a carbon monoxide gas, oxidizing the carbon monoxide gas to form a carbon dioxide gas, providing the hydrogen gas and the carbon dioxide gas to a hydrogen pump, applying a potential across the proton exchange membrane, separating at least a portion of the hydrogen gas from the carbon dioxide gas, and supplying the hydrogen gas to the fuel cell stack.

### DRAWINGS

The above, as well as other advantages of the present disclosure, will become readily apparent to those skilled in the art from the following detailed description, particularly when considered in the light of the drawings described hereafter.

FIG. 1 illustrates a schematic exploded perspective view of a PEM fuel cell stack (only two cells shown);

FIG. 2 is a schematic flow diagram showing a hydrogen pump according to an embodiment of the invention;

FIG. 3 is a schematic flow diagram showing the hydrogen pump of FIG. 2, further depicting a relationship with a cathode inlet of the PEM fuel cell stack;

FIG. 4 is a schematic flow diagram showing the hydrogen pump of FIG. 2, further depicting a relationship with a hydrogen storage device; and

FIG. 5 is a schematic flow diagram showing the hydrogen pump in communication with a reformate system.

### DETAILED DESCRIPTION OF THE INVENTION

The following description is merely exemplary in nature and is not intended to limit the present disclosure, application, or uses. It should also be understood that throughout the drawings, corresponding reference numerals indicate like or corresponding parts and features. In respect of the methods disclosed, the steps presented are exemplary in nature, and thus, are not necessary or critical.

For simplicity, only a two-cell stack (i.e. one bipolar plate) is illustrated and described hereafter, it being understood that a typical stack will have many more such cells and bipolar plates. Also for reasons of simplicity, only a single fuel cell stack (i.e. one quantity of fuel cells connected in series) is illustrated and described hereafter. One of ordinary skill in the art should further understand that more than one fuel cell stack, e.g. a dual-stack system, may be used within the scope of the present invention.

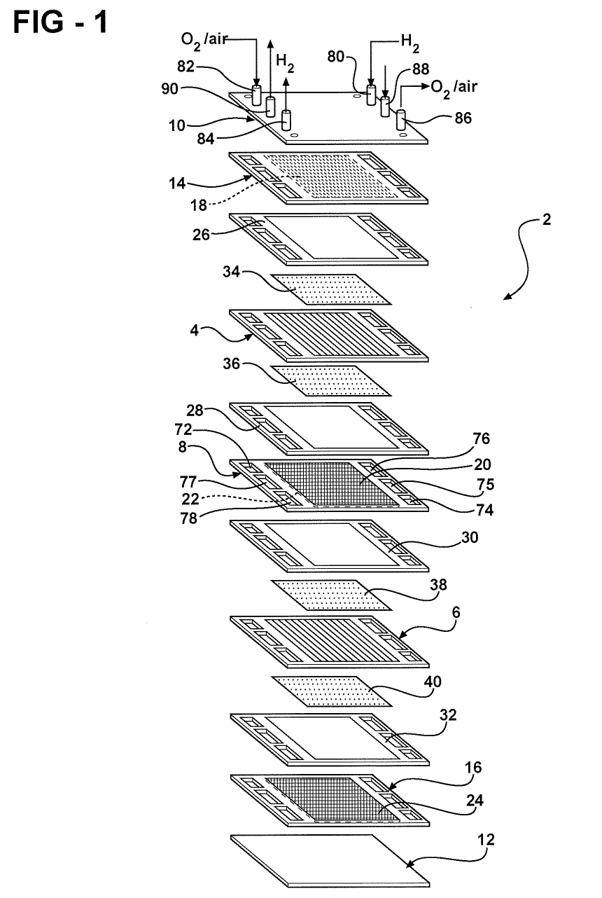

FIG. 1 depicts two-cell, bipolar PEM fuel cell stack 2 having a pair of MEAs 4, 6 separated from each other by an electrically conductive bipolar plate 8. The MEAs 4, 6 and bipolar plate 8 are stacked together between a pair of clamping plates 10,12, and a pair of unipolar end plates 14, 16. The clamping plates 10, 12 are electrically insulated from the end plates 14, 16 by a gasket or a dielectric coating (not shown). The unipolar end plates 14, 16, as well as both working faces of the bipolar plate 8, include a plurality of grooves or channels 18, 20, 22, 24 defining a flowfield for distributing fuel and oxidant gases (i.e., H₂ & O₂/air) over the faces of the MEAs 4, 6. Nonconductive gaskets 26, 28, 30, 32 provide seals and an electrical insulation between the several components of the fuel cell stack. Gas-permeable diffusion media 34, 36, 38, 40, e.g. carbon/graphite diffusion papers, abut an anode face and a cathode face of the MEAs 4, 6. The end plates 14, 16 abut the diffusion media 34, 40 respectively, while the bipolar plate 8 abuts the diffusion media 36 on the anode face of MEA 4, and abuts the diffusion media 38 on the cathode face of MEA 6.

An oxidant gas is supplied to the air supply manifold 72 of the fuel cell stack 2 via a cathode inlet conduit 82. A hydrogen gas is supplied to a hydrogen supply manifold 76 via an anode inlet conduit 80. An anode outlet conduit 84 and a cathode outlet conduit 86 are also provided for the H₂ and air exhaust manifolds, respectively. A coolant inlet conduit 88 and a coolant outlet conduit 90 are provided for supplying liquid coolant to, and removing coolant from, respectively, a coolant inlet manifold 75 and a coolant outlet manifold 77. It should be understood that the configurations of the various inlets 80, 82, 88 and outlets 84, 86, 90 in FIGS. 1 to 4 are for the purpose of illustration, and other configurations may be chosen as desired.

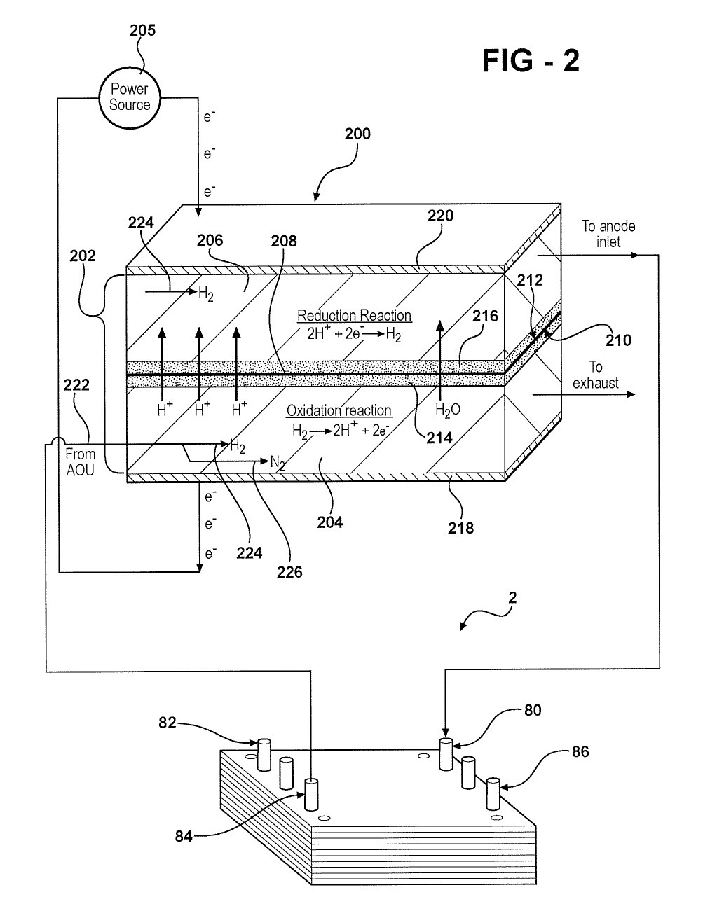

Referring now to FIG. 2, a schematic of a hydrogen pump 200 according to the present disclosure is provided. It should be understood that even though one hydrogen pump 200 is depicted for purposes of illustration, additional hydrogen pumps 200 can be used as desired. For example, one or more hydrogen pumps 200 can be used in series or in parallel within the scope of the present invention.

The structure and operation of the hydrogen pump 200 is similar to that of the fuel cell stack 2, but without the introduction of an oxidant gas. For example, hydrogen pump 200 includes a hydrogen pump MEA 202 having diffusion media 204, 206 with a PEM 208 disposed therebetween. As a nonlimiting example, the diffusion media 204, 206 include a gas-permeable material such as carbon or graphite diffusion paper. One of ordinary skill should understand that other materials may be used as the diffusion media 204, 206 as desired.

The PEM 208 has a first face 210 and a second face 212. A first electrode 214 including a catalyst is disposed on the face 210. A second electrode 216 having the catalyst is disposed on face 212. The first electrode 214 and the second electrode 216 are in electrical communication with a power source 205. One of skill should appreciate that an oxidation reaction (H₂→2H⁺+2e⁻), wherein a hydrogen gas 224 is oxidized to form a quantity of protons and a quantity of electrons, can take place at the first electrode 214. Furthermore, a reduction reaction (2H⁺+2e⁻→H₂), wherein the hydrogen gas 224 is re-combined, can take place at the second electrode 216.

It should be appreciated that, because both the oxidation and the reduction reactions in the hydrogen pump 200 involve hydrogen reactions, the first and second electrodes 214, 216 can have a lower loading of catalyst than may typically be required for a fuel cell where oxidant gases are utilized. In particular embodiments, the first and second electrodes 214, 216 include the catalyst in an amount less than about 0.1 mg/cm². In one embodiment of the present invention, the catalyst loading is about 0.05 mg/cm². In a further embodiment of the disclosure, the catalyst loading is about 0.01 mg/cm².

The hydrogen pump 200 further includes conductive end plates 218, 220 disposed adjacent the diffusion media 204, 206. The conductive end plates 218, 220 each have a flowfield (not shown) formed thereon for gas distribution. Similar to the end plates 14, 16 of the fuel cell stack 2, the flowfields formed in the conductive end plates 218, 220 of the hydrogen pump 200 can include one or more grooves or flow channels (not shown) to facilitate a distribution of gaseous reactants.

The hydrogen pump 200 is in communication with the anode inlet 80 and the anode outlet 84 of the fuel cell stack 2. The first electrode 214 of the hydrogen pump 200 is configured to accept an anode outlet stream 222 from the anode outlet 84. The anode outlet stream can include a hydrogen gas 224 and one or more of an inert gas 226 such as a nitrogen gas and a carbon dioxide gas, for example. The anode outlet stream 222 can also include water.

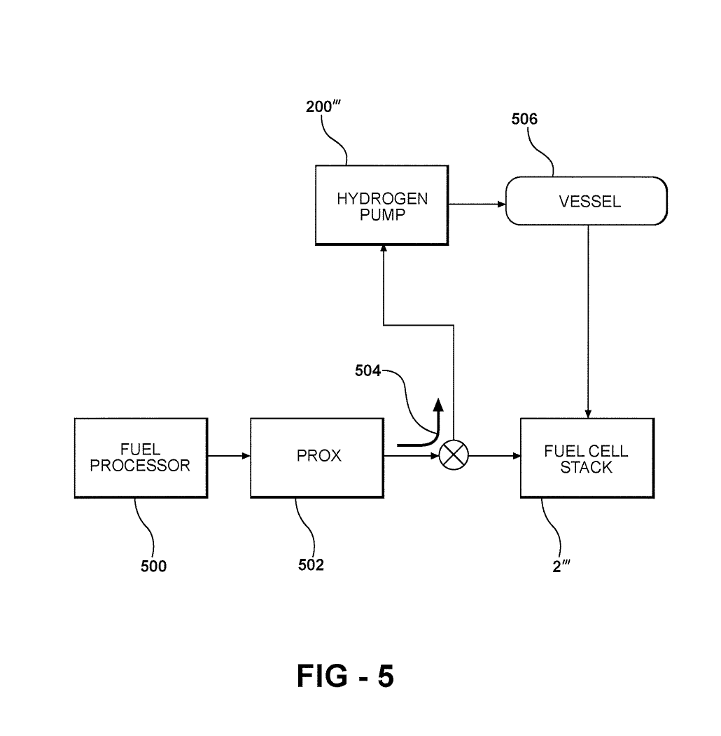

The first electrode 214 is configured to exhaust at least a portion of the inert gas 226 from the fuel cell system. Typically, the inert gas 226 is exhausted to the atmosphere outside of the hydrogen pump 200. In another embodiment, the hydrogen gas 224 from the second electrode 216 can be combined with the cathode outlet stream 86 and exhausted. The second electrode 216 is configured to supply at least a portion of the hydrogen gas 224 supplied from the anode outlet stream 222 to the anode inlet 80, where the hydrogen gas 224 can be used as a fuel for the fuel cell stack 2. In a further embodiment, at least a portion of the hydrogen gas 224 separated from the inert gas 226 is compressed by the hydrogen pump 200 and stored for supply to the anode inlet 80. As a nonlimiting example, the separated hydrogen gas 224 is compressed to a pressure of at least about 100 bars and is stored in a buffer or high pressure vessel (shown in FIG. 5).

The first electrode 214 and the second electrode 216 are in electrical communication with a power source 205. The power source 205 typically is a direct current power source. For example, the power source 205 can include a battery. In a further embodiment, the power source includes a vehicle regenerative power system, for example a regenerative braking system that recaptures kinetic energy during a vehicle braking operation and stores the energy electrically. In one embodiment of the present invention, the power source 205 includes the fuel cell stack 2. In a further embodiment, the hydrogen pump 200 acts as an independently controlled load for the fuel cell stack 2. As an independently controlled load, the hydrogen pump 200 is not arranged as part of the fuel cell stack 2, i.e. one or more hydrogen pumps 200 are not disposed intermittently as cells throughout the fuel cell stack 2. Rather, it should be understood that hydrogen pump 200 acting as an independently controlled load is not in direct electrical contact with individual fuel cells, and instead constitutes a load for the fuel cell stack 2 as a whole. For example, the hydrogen pump 200 is disposed downstream of the anode outlet conduit 84 of the fuel cell stack 2.

The direct current from the power source 205 can be applied across the proton exchange membrane 208 to “pump” protons therethrough. In particular embodiments, upon application of the current across proton exchange membrane 208, the hydrogen gas 224 present in the anode outlet stream 222 oxidizes at the first electrode 214. The oxidation enables hydrogen ions (protons) to transfer through the membrane 208 from first electrode 214 to the second electrode 216 while the electrons pass through the power source 205 to the second electrode 216. At the second electrode 216, the hydrogen ions transferred through the proton exchange membrane 208 recombine with the electrons to re-form the hydrogen gas 224. Water and the inert gases 226, including nitrogen gas, can be exhausted from the first electrode 214 via an exhaust conduit (not shown).

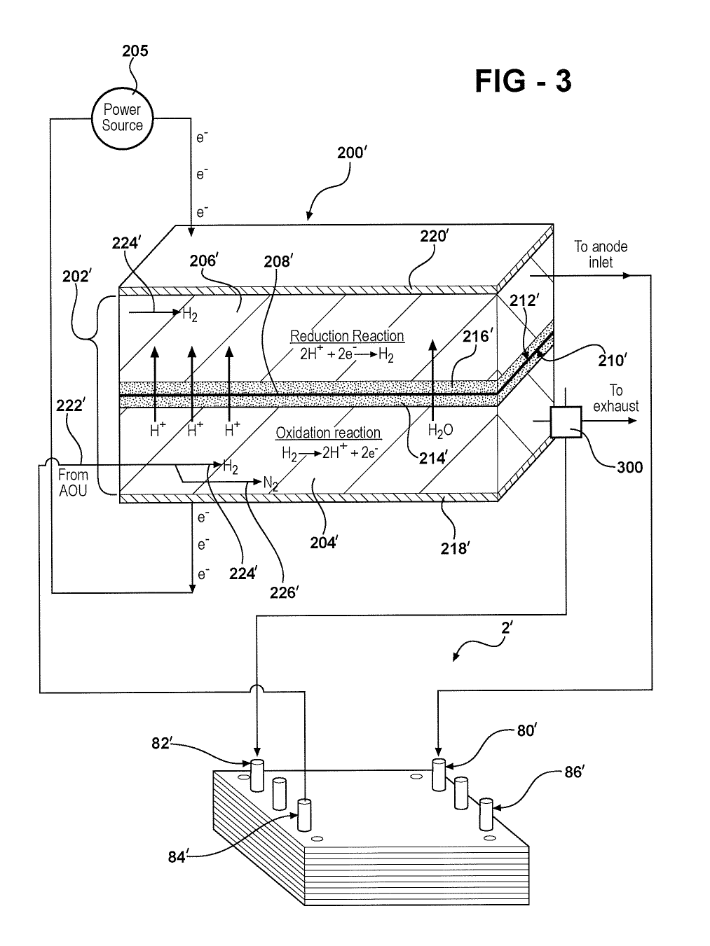

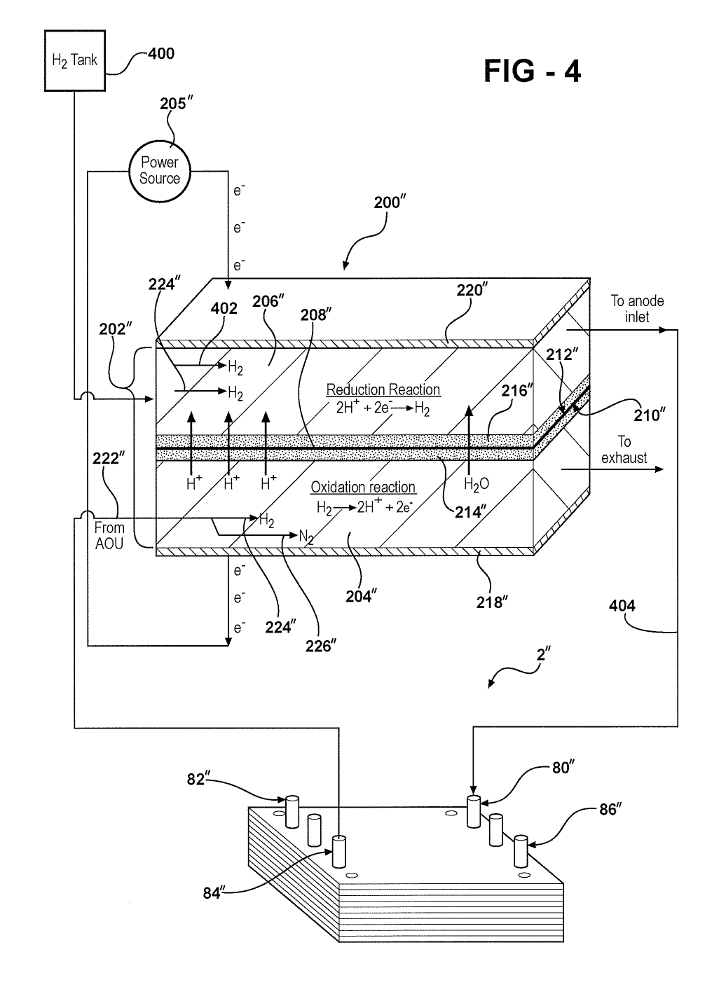

With references to FIGS. 3 and 4, further embodiments of the present invention are shown. Like structures repeated from FIG. 1 include the same reference numerals with either a prime (′), double-prime (″), or triple-prime (′″).

As depicted in FIG. 3, the hydrogen pump 200′ is in communication with the cathode inlet 82′. In an illustrative embodiment, the hydrogen pump 200′ is configured to supply at least a portion of the inert gas 226′ from the anode outlet stream 222′ to the cathode inlet 82′ during a start-up phase and/or a shut-down phase of the fuel cell stack 2′. In particular embodiments, the first electrode 214′ is in communication with the cathode inlet 82′ and is configured to supply the inert gas 226′ separated from the anode outlet stream 222′ as a protective gas blanket to the cathode 82′ of the fuel cell stack 2′ for the start-up phase and/or the shut-down phase.

As used herein, the term start-up phase is defined to include a period of time during which the fuel cell stack 2′ is being activated or started. The activation may include, for example, introducing gaseous reactants to the fuel cell stack 2′, as well as a brief period of time preceding and succeeding the introduction of gaseous reactants to the fuel cell stack 2′. Similarly, the term shut-down phase is defined to include a period of time during which the fuel cell stack 2′ is being deactivated. The deactivation may include, for example, interrupting the introduction of gaseous reactants to the fuel cell stack 2′, as well as a brief period of time preceding and succeeding the interruption. Further, an operational phase in which gaseous reactants are being supplied and/or a load is being applied to the fuel cell stack 2′, for example, is located temporally between the start-up phase and the shut-down phase.

In one embodiment, the fuel cell system includes at least one valve 300 disposed between the first electrode 214′ and the cathode inlet 82′. As shown, the valve 300 is a three way valve, although other valve types or valve combinations can be used as desired. The valve 300 is configured to supply the inert gas 226′ to the cathode inlet 82′ during the start-up phase and/or the shut-down phase of the fuel cell stack 2′. Furthermore, the valve 300 is configured to exhaust the inert gas 226′ during the operational phase. Thus, the inert gas 226′ is only supplied to the cathodes of the fuel cell stack 2′ when the presence of the inert gas 226′ is desired to act to inhibit start-stop degradation. It should be understood that other methods for supplying the inert gas 226′ to the cathode inlet 82′ can also be used.

It should be understood that the hydrogen pump 200′ of the present invention can be employed to militate against a start-stop degradation of the fuel cell stack 2′. Such a method includes introducing the anode outlet stream 222′ from the fuel cell stack 2′ to the hydrogen pump 200′, wherein the anode outlet stream includes the hydrogen gas 224′ and the inert gas 226′. A potential is applied across the proton exchange membrane 208′ of the hydrogen pump 200′ from, for example, a battery or the fuel cell stack 2′. As a result of the potential being applied, at least a portion of the inert gas 226′ is separated from the anode outlet stream 222′. In particular, the hydrogen gas 224′ in the anode outlet stream 222′ is oxidized and removed from the anode outlet stream 222′ to leave the inert gas 226′ as a remainder. The inert gas 226′ is then supplied to the cathode inlet 82′ of the fuel cell stack 2′ during the start-up phase and/or the shut-down phase. The inert gas 226′ covers or blankets the cathodes of the fuel cell stack 2′, displacing any air or oxygen present, and militates against start-stop degradation. The degradation may include an oxidative corrosion of the cathodes of the fuel cell stack 2′, for example.

When the fuel cell stack 2′ is in an operational phase, however, the inert gas 226′ is exhausted to the atmosphere external to the fuel cell stack 2′ and the hydrogen pump 200′. Typically, a hydrogen content of the inert gas 226′ is lower than about 4%, or the lower explosive limit. In particular embodiments, the hydrogen content of the inert gas 226′ is lower than about 1%. In an illustrative embodiment, the hydrogen content of the inert gas 226′ being exhausted from the hydrogen pump 200′ is lower than about 0.5%.

As seen in FIG. 4, the hydrogen pump 200″ of the present disclosure is in communication with a hydrogen storage device 400. A nonlimiting example of a suitable hydrogen storage device 400 includes a hydrogen tank, such as a Type IV pressure vessel, for example. One of ordinary skill in the art should appreciate that other devices for storing hydrogen can also be used. Such alternative devices can include, for example, metal-hydride storage devices, glass microsphere-based devices, metal-organic framework devices, and nanotube-based devices.

In a particular embodiment, the hydrogen storage device 400 is in communication with the second electrode 216″ of the hydrogen pump 200″. The hydrogen storage device 400 is configured to supply a hydrogen feed stream 402 to the second electrode 216″. The hydrogen feed stream 402 can include, for example, a substantially pure hydrogen gas. It should be understood that as the anode outlet stream 222″ is delivered to the first electrode 214″, water from the anode outlet stream 222″ can migrate across the proton exchange membrane 208″ to the second electrode 216″. The presence of water in the second electrode 216″ is effective to at least partially humidify the hydrogen feed stream 402 from the hydrogen storage device 400. The humidified hydrogen feed stream 402, in addition to the re-combined hydrogen gas 224″, can be delivered to the anode inlet 80″.

A method for humidifying a hydrogen feed stream 402 can include first introducing the anode outlet stream 222″ from the fuel cell stack 2″ to the first electrode 214″ of the hydrogen pump 200″. Second, a potential is applied across the proton exchange membrane 208″ of the hydrogen pump 200″, thereby separating at least a portion of the hydrogen gas 224″ from the anode outlet stream 222′. The portion of the hydrogen gas 224′ is oxidized and migrates across the proton exchange membrane 208′ to the second electrode 216′. In addition, water present in the anode outlet gas 222′ also migrates across the proton exchange membrane 208′ and is present at the second electrode 216′. The water acts to humidify the hydrogen feed stream 402 and the re-combined hydrogen gas 224′. The humidified hydrogen feed stream 402 and the re-combined hydrogen gas 224′ are combined to form an anode inlet stream 404. In particular embodiments, the anode inlet stream 404 has a relative humidity that promotes an effective conduction of protons in the fuel cell stack 2″.

As shown in FIG. 5, a further embodiment of the invention includes the hydrogen pump 200′″ being in communication with a reformate system and a fuel cell stack 2′″. The reformate system includes a fuel processor 500 and a preferential oxidation (PROX) unit 502. Suitable fuel processors 500 are well known in the art and are adapted to partially oxidize or “reform” hydrocarbons such as, for example, gasoline. The fuel processor 500 typically yields a gaseous mixture of fuel gases (a “reformate stream”) including hydrogen gas and carbon monoxide (CO). Suitable preferential oxidation units 502 are also well known in the art and are adapted to remove carbon monoxide from the gaseous mixture of hydrogen and carbon monoxide. Preferential oxidation units 502 can initiate, for example, a catalytic oxidation of the carbon monoxide and further yield an inert carbon dioxide gas 226′″.

In an illustrative embodiment, the hydrogen pump 200′″ is configured to receive a reformate stream 504 from the preferential oxidation unit 502, the reformate stream 504 having a mixture of the hydrogen gas 224′″ and an inert carbon dioxide gas 226′″. The hydrogen pump 200′″ is further adapted to extract the hydrogen gas 224′″ as described herein, separating the hydrogen gas 224′″ from the carbon dioxide gas 226′″. In particular embodiments, the separated hydrogen gas 224′″ is stored in a buffer or high pressure vessel 506. The high pressure vessel 506 is in communication with the hydrogen pump 200′ and the fuel cell stack 2′″. In one embodiment, the high pressure vessel 506 is also the hydrogen storage device 400. Suitable high pressure vessels 506 are know in the art and can be selected as desired.

In a further embodiment, the high pressure vessel 506 is adapted to supply the stored hydrogen gas 224′″ during a cold start-up of the fuel cell stack 2′″. For example, the high pressure vessel 506 is able to store a sufficient amount of the hydrogen gas 224′″ from the hydrogen pump 200′″ to enable the fuel cell stack 2′″ to generate power for at least the start-up phase. Illustratively, the high pressure vessel 506 is adapted to store a sufficient amount of the hydrogen gas 224′″ to supply the fuel cell stack 2′″ for a period of time until the fuel processor 500 has produced a sufficient amount of hydrogen gas 224′″ and can supply the fuel cell stack 2′″ independently. As a nonlimiting example, the high pressure vessel 506 has a volume of about 10 liters. In a further nonlimiting example, the high pressure vessel 506 may provide a sufficient amount of the hydrogen gas 224′″ to generate up to about 120 kW of power during approximately the first two minutes of the fuel cell stack 2′″ operation.

The present invention further includes a method for operating the fuel cell system. The method first includes the step of introducing a reformate stream from the fuel processor 500 to a preferential oxidation unit 502. The reformate stream includes the hydrogen gas 224′″ and the carbon monoxide gas. The carbon monoxide gas is then oxidized to form the inert carbon dioxide gas 226′″. The mixture of the hydrogen gas 224′″ and the inert carbon dioxide gas 226′″ is provided to the hydrogen pump 200′″ according to the present disclosure. When an electric potential is applied to the hydrogen pump 200′″, at least a portion of the hydrogen gas 224′″ is separated for supply to the fuel cell stack 2′″. In a particular embodiment, the hydrogen gas 224′″ is temporarily stored in the pressure vessel 506 prior to being supplied to the fuel cell stack 2′″, for example during the start-up phase for the fuel cell stack 2′″.

It should be appreciated that, when the hydrogen pump 200 of the present invention is a load on the fuel cell stack 2, the power required to operate the hydrogen pump 200 can be lower than a power output of the fuel cell stack. The efficiency of the fuel cell system is further optimized, for example, by powering the hydrogen pump 200 with a power output of the battery or the vehicle regenerative power system.

It has been surprisingly discovered that, at a recirculation rate of 5% or less, the power required to operate the hydrogen pump 200 up to 1.2 A/cm² is less than about 500 W in an 80 kW to 100 kW system. The recirculation rate is defined as a flow rate of the hydrogen in the anode inlet stream divided by a hydrogen flow rate from a hydrogen storage device minus one. When the recirculation rate is 5% or less, the hydrogen content of the inert gas 226 can be from about 0.1% to about 0.5% by volume. It should be understood that other recirculation rates can be used, for example, to optimize the power output of the fuel cell stack 2 relative to power consumed by the hydrogen pump 200.

The hydrogen pump 200 of the present disclosure provides a means for militating against start-stop degradation. Furthermore, the hydrogen pump 200 provides an opportunity to humidify the hydrogen feed stream 402, as desired for proper operation of the fuel cell stack 2. It should also be understood that the hydrogen pump 200 of the present invention replaces standard recirculation pumps, bleed valves, catalytic combustors, and other components, thus optimizing the mass and volume of the fuel cell system. In particular, as the hydrogen pump 200 separates the hydrogen gas 224 from the inert gas 226 (including nitrogen gas), the inert gases 226 do not accumulate in the fuel cell stack 2 which would necessitate a bleed valve for removal. Having an optimized mass and volume, fuel efficiency is also optimized with the use of the hydrogen pump 200 of the present invention.

As the hydrogen pump 200 removes the hydrogen gas 224, a catalytic combustor typically used to burn the residual hydrogen gas exhausted from the fuel cell stack 2 is not required. This further optimizes a thermal load on the fuel cell system which is otherwise produced by burning the excess hydrogen gas 224.

While certain representative embodiments and details have been shown for purposes of illustrating the invention, it will be apparent to those skilled in the art that various changes may be made without departing from the scope of the disclosure, which is further described in the following appended claims.

What is claimed is:

1. A fuel cell system comprising:
a fuel cell stack including a fuel cell having an anode with an inlet and an outlet, and a cathode and
a hydrogen pump in communication with the anode outlet and the anode inlet and adapted to separate a hydrogen gas from an inert gas in an anode outlet stream, the hydrogen pump including a proton exchange membrane disposed between a first electrode and a second electrode in electrical communication with a power source, wherein the first electrode is configured to accept the anode outlet stream and to exhaust the inert gas, and the second electrode is configured to supply at least a portion of the hydrogen gas to the anode inlet.

2. The fuel cell system of claim 1, the fuel cell stack including a cathode inlet, wherein the first electrode is further configured to supply at least a portion of the inert gas to the cathode inlet during at least one of a start-up phase and a shut-down phase of the fuel cell stack.

3. The fuel cell system of claim 2, wherein the fuel cell stack includes a valve configured to:
a.) supply the inert gas to the cathode inlet during the at least one of the start-up phase and the shut-down phase, and
b.) exhaust the inert gas during an operational phase between the start-up phase and the shut-down phase.

4. The fuel cell system of claim 1, wherein the power source includes the fuel cell stack.

5. The fuel cell system of claim 4, wherein the hydrogen pump is an independently controlled load for the fuel cell stack.

6. A method for operating a fuel cell system, the method comprising the steps of:
introducing an anode outlet stream from a fuel cell stack to a hydrogen pump, wherein the anode outlet stream includes a hydrogen gas and an inert gas, the hydrogen pump including a proton exchange membrane disposed between a first electrode and a second electrode, wherein the first electrode and the second electrode are in electrical communication with a power source;
applying a potential across the proton exchange membrane;
separating at least a portion of the inert gas from the anode outlet stream; and
supplying a cathode inlet stream to the fuel cell stack during at least one of a start-up phase and a shut-down phase of the fuel cell stack, the cathode inlet stream including the inert gas separated from the anode outlet stream.

7. The method of claim 6, further comprising the step of exhausting the cathode inlet stream during an operational phase between the start-up phase and the shut-down phase.

8. The method of claim 6, further comprising the step of supplying an anode inlet stream including at least a portion of the hydrogen gas from the anode outlet stream to the fuel cell stack.

9. The method of claim 6, wherein the anode inlet stream is supplied to an anode of the fuel cell stack.

10. The method of claim 6, wherein the potential across the proton exchange membrane is applied from the fuel cell stack.

11. The method of claim 6, wherein the separating of the inert gas from the anode outlet stream includes oxidizing the hydrogen gas to form to a quantity of protons and a quantity of electrons.

12. The method of claim 6, wherein the cathode inlet stream has a hydrogen gas content of less than about 4% by weight.

13. The method of claim 6, wherein the cathode inlet stream militates against a start-stop degradation of the fuel cell stack.

14. The method of claim 13, wherein the start-stop degradation includes corrosion of the cathode.

15. A method for operating a fuel cell system, the method comprising the steps of:
introducing an anode outlet stream from a fuel cell stack to a hydrogen pump, wherein the anode outlet stream includes a hydrogen gas, the hydrogen pump including a proton exchange membrane disposed between a first electrode and a second electrode, wherein the first and second electrodes are in electrical communication with a power source;
applying a potential across the proton exchange membrane;
separating at least a portion of the hydrogen gas from the anode outlet stream;
humidifying a hydrogen feed stream; and
supplying an anode inlet stream including the humidified hydrogen feed stream and the portion of hydrogen gas from the anode outlet stream to the fuel cell stack.

16. The method of claim 15, the anode outlet stream further including water, wherein the hydrogen feed stream is humidified with the anode outlet stream.

17. The method of claim 16, wherein the hydrogen feed stream is supplied by a hydrogen storage device.

18. A fuel cell system comprising:
a fuel cell stack including a fuel cell having an anode with an anode inlet and an anode outlet;
a fuel processor adapted to generate a reformate stream from a hydrocarbon source, the reformate stream including a hydrogen gas and a carbon monoxide gas;
a preferential oxidation unit in communication with the fuel processor and configured to oxidize the carbon monoxide gas and form a carbon dioxide gas; and
a hydrogen pump in communication with the preferential oxidation unit, the hydrogen pump including a proton exchange membrane disposed between a first electrode and a second electrode, wherein the first and second electrodes are in electrical communication with a power source, the hydrogen pump adapted to receive and separate the hydrogen gas and the carbon dioxide gas,
wherein the hydrogen pump is further configured to supply the hydrogen gas to the anode inlet of the fuel cell stack.

19. The fuel cell system of claim 18, wherein the fuel cell system includes a pressure vessel in communication with the hydrogen pump and the fuel cell stack, the pressure vessel configured to receive the hydrogen gas from the hydrogen pump and provide the hydrogen gas to the pressure vessel as desired.

20. A method for operating a fuel cell system, the method comprising the steps of:
introducing a reformate stream from a fuel processor to a preferential oxidation unit, the reformate stream including a hydrogen gas and a carbon monoxide gas;
oxidizing the carbon monoxide gas to form a carbon dioxide gas;
providing the hydrogen gas and the carbon dioxide gas to a hydrogen pump, the hydrogen pump including a proton exchange membrane disposed between a first electrode and a second electrode, wherein the first and second electrodes are in electrical communication with a power source;
applying a potential across the proton exchange membrane;
separating at least a portion of the hydrogen gas from the carbon dioxide gas; and
supplying the hydrogen gas to the fuel cell stack.
